(19) United States
(12) Patent Application Publication
(10) Pub. No.: US 2010/0241337 A1
(43) Pub. Date: Sep. 23, 2010

(54) APPARATUS FOR AND METHOD OF CONTROLLING ENGINE

(75) Inventor: Satoru WATANABE, Isesaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Automotive Systems, Ltd.

(21) Appl. No.: 12/719,113

(22) Filed: Mar. 8, 2010

(30) Foreign Application Priority Data
Mar. 19, 2009 (JP) 2009-068845

(51) Int. Cl. F02D 41/00; F01L 1/34

(52) U.S. Cl. 701/105; 123/90.17

(57) ABSTRACT

There is a control apparatus of an engine including a variable valve timing mechanism having a locking mechanism for locking a rotation phase of a camshaft with respect to a crankshaft to a target for the engine starting. In a case where the rotation phase has not reached the target for the engine starting at the time of the engine starting, fuel injection to the engine is restricted from the commencement of the engine starting until an integrated value of valve opening frequencies reaches a threshold, and when the integrated value of the valve opening frequencies has reached the threshold, it is regarded that the rotation phase is locked to the target for the engine starting by a locking mechanism, and fuel supply to the engine is permitted.

### BACKGROUND OF THE INVENTION

1. Field of the Invention

The present invention relates to a control apparatus applied to an engine including a variable valve timing mechanism that changes a rotation phase of a camshaft with respect to a crank shaft.

2. Description of the Related Art

In Japanese Laid-open (Kokai) Patent Application Publication No. 2004-324421, it is described to restrict fuel supply to an engine, in an engine including a variable valve timing mechanism having a locking mechanism that locks a rotation phase of a camshaft to a target for the engine starting, in a case where the rotation shaft is not locked to the target at the time of the engine starting.

Incidentally, in the variable valve timing mechanism, an actual rotation phase is detected from a sensor output signal indicating a rotation position of the crankshaft and a sensor output signal indicating a rotation position of the camshaft, and if the actual rotation phase agrees with the target, a lock state is determined.

However, at the time of the engine starting, because variation of engine rotation speed is large to thereby decrease detection accuracy of the rotation phase, there is a problem in that it is difficult to appropriately restrict fuel supply.

### SUMMARY OF THE INVENTION

It is therefore an object of the present invention to provide an apparatus for and method of controlling an engine that can stably determine that a variable valve timing mechanism is locked to a target rotation phase, and that can appropriately restrict fuel supply.

To achieve the above object, a control apparatus according to the present invention includes; an integration unit that integrates valve opening frequencies of an engine valve to be driven by a camshaft, a determination unit that determines whether or not the variable valve timing mechanism is locked to a target at time of the engine starting, and a restriction unit that restricts supply of fuel to the engine from the commencement of the engine starting until an integrated value of the valve opening frequencies reaches a threshold, in a case where the variable valve timing mechanism is not locked to the target.

Moreover, a control method according to the present invention includes steps of; determining whether or not the variable valve timing mechanism is locked to the target at the commencement of the engine starting, integrating valve opening frequencies of an engine valve to be driven by the camshaft in a case where the variable valve timing mechanism is not locked to the target, and restricting supply of fuel to the engine until an integrated value of the valve opening frequencies reaches a threshold.

The other objects and features of this invention will become understood from the following description with reference to the accompanying drawings.

### BRIEF DESCRIPTION OF THE DRAWINGS

FIG. 1 is a view illustrating a vehicle engine in an embodiment of the present invention;

FIG. 2 is a perspective view illustrating a variable valve lift mechanism installed in the engine;

FIG. 3 is a partial enlarged view illustrating the variable valve lift mechanism;

FIG. 4 is a sectional view illustrating a variable valve timing mechanism installed in the engine;

FIG. 5 is a graph illustrating a change in opening characteristics of an inlet valve due to the variable valve lift mechanism and the variable valve timing mechanism according to the embodiment;

FIG. 6 is a partially enlarged view illustrating a locking mechanism installed in the variable valve timing mechanism;

FIG. 7 is a flowchart illustrating fuel injection control at time of the engine starting in the embodiment; and

FIG. 8 is a sectional view illustrating the locking mechanism of the variable valve timing mechanism.

### DESCRIPTION OF THE PREFERRED EMBODIMENTS

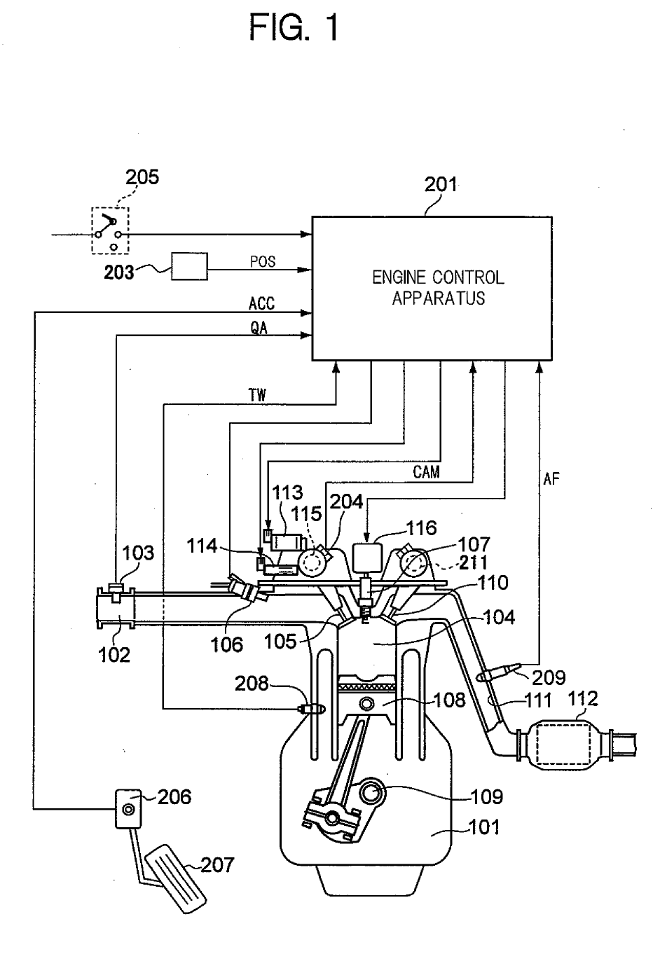

FIG. 1 is a view illustrating a vehicle engine (internal combustion engine) to which a control apparatus according to the present invention is applied.

An engine 101 illustrated in FIG. 1 is an inline four-cylinder gasoline engine, however it may be a V-engine or a horizontal opposed engine, and the number of cylinders is not limited to four.

An intake airflow sensor 103 that detects intake airflow QA of engine 101, is provided in an inlet pipe 102 of engine 101.

For intake airflow sensor 103, for example, a hot-wire flowmeter that detects a mass flow rate is adopted.

An inlet valve 105 serving as the engine valve, opens and closes an inlet port of a combustion chamber 104 of each cylinder, and a fuel injection valve 106 is arranged for each cylinder in inlet pipe 102 on an upstream side of inlet valve 105.

Engine 101 may be a cylinder direct injection engine in which fuel injection valve 106 directly injects fuel into combustion chamber 104.

The fuel injected by fuel injection valve 106 is sucked into combustion chamber 104 via inlet valve 105 together with air, and ignited and burns by spark ignition by a spark plug 107, to rotate a crankshaft 109 by pressing a piston 108 toward crankshaft 109 by combustion pressure.

Moreover, an exhaust valve 110 serving as an engine valve, opens and closes an exhaust port of combustion chamber 104. When exhaust valve 110 opens, exhaust gas is exhausted to an exhaust pipe 111.

In exhaust pipe 111, a catalytic converter 112 that includes a three-way catalyst or the like and that purifies the exhaust gas by a catalytic action, is arranged.

Inlet valve 105 and exhaust valve 110 are opened in accordance with rotation of an inlet camshaft 115 and an exhaust camshaft 211.

Exhaust valve 110 is opened with a constant lift characteristic, however, the lift characteristic of inlet valve 105 is changed by a variable valve lift mechanism 113 and a variable valve timing mechanism 114.

Variable valve lift mechanism 113 continuously changes a valve working angle and the maximum valve lift of inlet valve 105. Variable valve timing mechanism 114 continuously changes a central phase of the valve working angle of inlet valve 105 by changing a rotation phase of inlet camshaft 115 with respect to crankshaft 109.

The valve working angle is a crank angle from opening valve timing IVO to closing valve timing IVC of the engine valve.

Moreover, an ignition module 116 is connected to spark plug 107.

Ignition module 116 includes an ignition coil and a power transistor that controls power distribution to the spark coil.

An engine control apparatus 201 controls fuel injection valve 106, variable valve lift mechanism 113, variable valve timing mechanism 114, and ignition module 116.

Engine control apparatus 201 includes a microcomputer to which is input signals from various sensors and switches.

Furthermore, engine control apparatus 201 performs arithmetic processing according to a program stored beforehand, to thereby calculate manipulated variables for fuel injection valve 106, variable valve lift mechanism 113, variable valve timing mechanism 114, and ignition module 116, and outputs the manipulated variables.

Engine 101 includes, as the sensors and the switches, intake airflow sensor 103, a crank angle sensor 203 that generates a pulse signal POS every time crankshaft 109 rotates by a unit angle, an accelerator opening sensor 206 that detects a stroke amount of an accelerator pedal 207, a cam angle sensor 204 that outputs an angle signal CAM of inlet camshaft 115, an air-fuel ratio sensor 209 that detects an air-fuel ratio AF based on oxygen concentration in the exhaust in exhaust pipe 111 on the upstream side of catalytic converter 112, and an ignition switch 205 which is a main switch for operating or stopping engine 101.

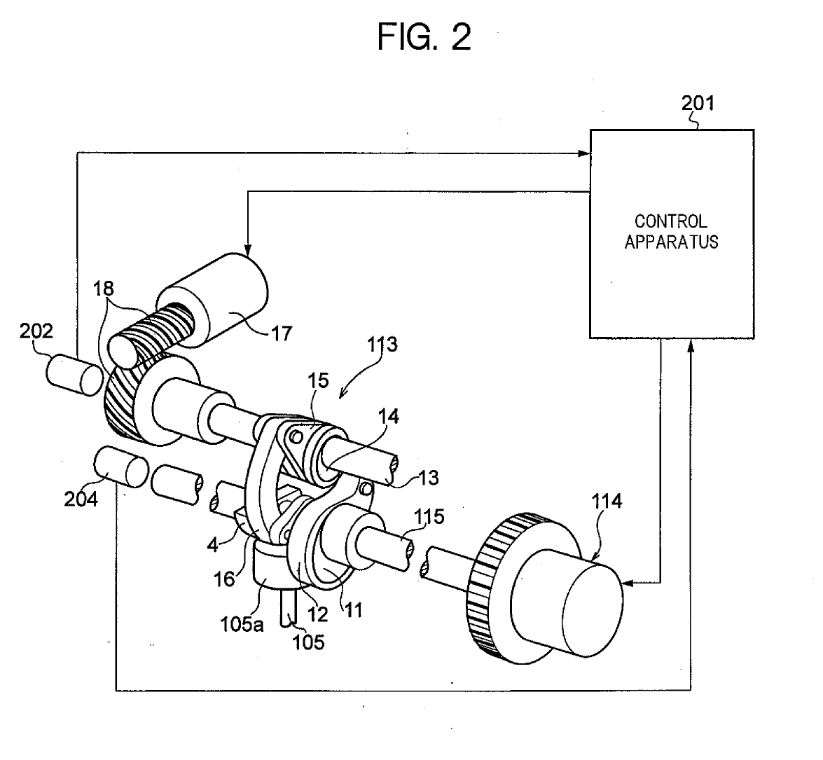

FIG. 2 is a perspective view illustrating variable valve lift mechanism 113.

Inlet camshaft 115 is rotatably supported along a cylinder train direction above inlet valve 105.

An oscillating cam 4 that abuts against a valve lifter 105a of inlet valve 105 to open inlet valve 105, is fitted around inlet camshaft 115 so as to be relatively rotatable.

Variable valve lift mechanism 113 is arranged between inlet camshaft 115 and oscillating cam 4, and variable valve timing mechanism 114 is arranged at one end of inlet camshaft 115.

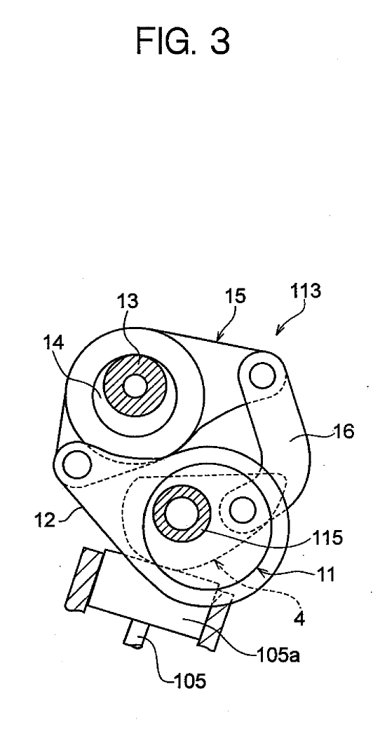

As illustrated in FIG. 2 and FIG. 3, variable valve lift mechanism 113 includes; a circular drive cam 11 provided eccentrically and fixedly with respect to inlet camshaft 115, a ring-shaped link 12 fitted around drive cam 11 so as to be relatively rotatable, a control shaft 13 extending in the cylinder train direction substantially parallel with inlet camshaft 115, a circular control cam 14 provided eccentrically and fixedly with respect to control shaft 13, a rocker arm 15 fitted around control cam 14 so as to be relatively rotatable with one end thereof being connected to the end of ring-like link 12, and a rod-shaped link 16 that connects the other end of rocker arm 15 to oscillating cam 4.

Control shaft 13 rotates within a predetermined control range via a gear train (decelerator) 18 by driving a motor (actuator) 17.

According to the configuration described above, when inlet camshaft 115 rotates in synchronization with crankshaft 109, ring-shaped link 12 substantially translates the movement via drive cam 11, and together with this, rocker arm 15 oscillates about the central axis of control cam 14, and oscillating cam 4 oscillates via rod-shaped link 16 to open inlet valve 105.

Moreover, by controlling the drive of motor 17 to change an angle of control shaft 13, the position of the central axis of control cam 14, which is the center of oscillation of rocker arm 15, is changed to thereby change the posture of oscillating cam 4.

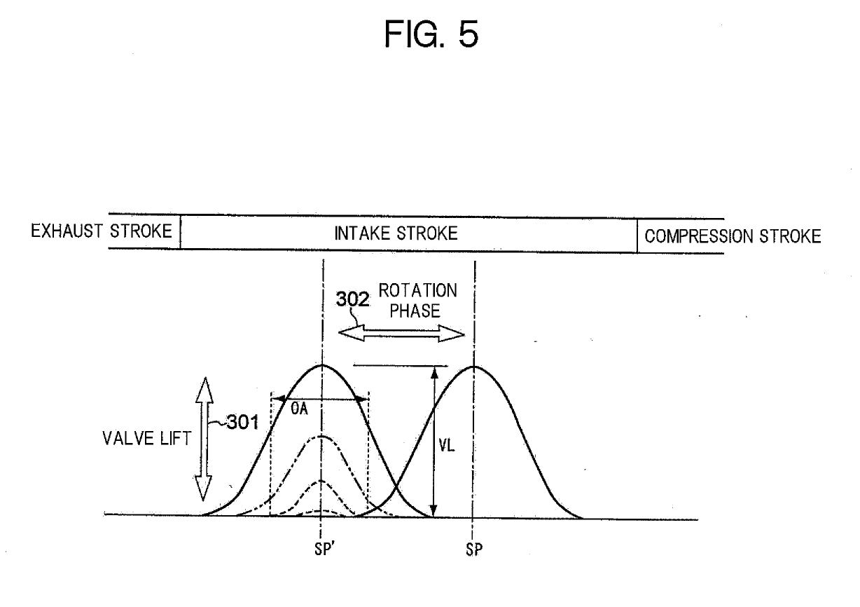

As a result, as illustrated by the arrow 301 in FIG. 5, a valve working angle OA of inlet valve 105 continuously changes together with the maximum valve lift VL, while a central phase SP of the valve working angle of inlet valve 105 remains approximately constant.

Variable valve lift mechanism 113 may be one in which the central phase of the valve working angle changes with a change of the valve working angle and the maximum valve lift.

Moreover, variable valve lift mechanism 113 may be a mechanism in which the valve working angle and the maximum valve lift of the engine valve are made variable in accordance with an axial displacement of the control shaft.

Engine control apparatus 201 receives an output signal of an angle sensor 202 that outputs a signal in accordance with the angle of control shaft 13, and detects the angle of control shaft 13 based on the output signal of angle sensor 202.

Moreover, engine control apparatus 201 calculates a target angle of control shaft 13 in accordance with an operation condition such as an engine load or engine rotation speed, and feedback-controls a manipulated variable of motor 17 so that the angle of control shaft 13 approaches the target angle.

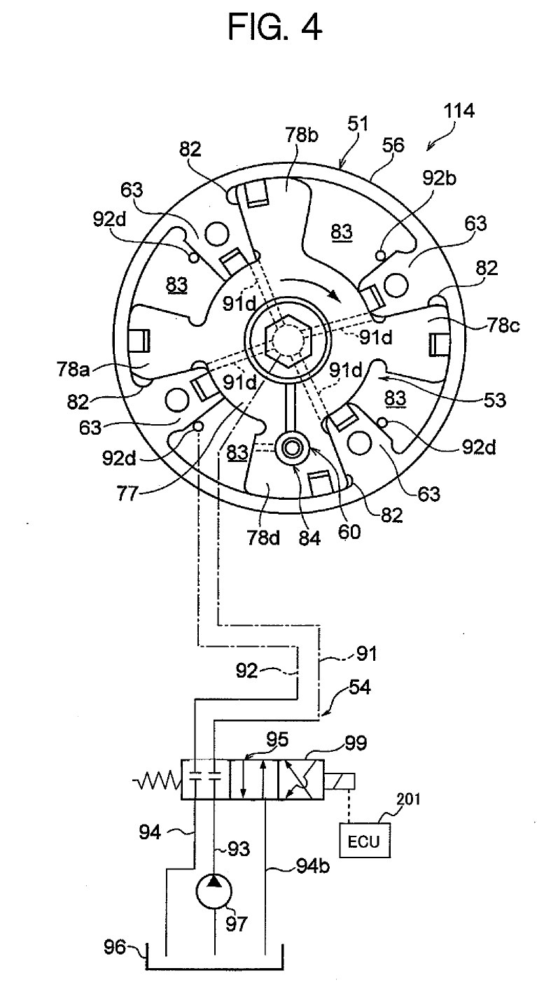

FIG. 4 illustrates variable valve timing mechanism 114.

Variable valve timing mechanism 114 includes; a cam sprocket (timing sprocket) 51, a rotation member 53 rotatably housed in cam sprocket 51, a hydraulic circuit 54 that relatively rotates rotation member 53 with respect to cam sprocket 51, and a locking mechanism 60 that mechanically locks a relative rotation position of cam sprocket 51 and rotation member 53 at a predetermined position. Cam sprocket 51 includes; a rotating section (not shown) having gear teeth engaged with a timing chain or a timing belt on an outer circumference thereof, a housing 56 that rotatably houses rotation member 53, and a cover (not shown) that closes off an opening of housing 56.

Housing 56 has a cylindrical shape with front and back ends being opened, and on an inner peripheral surface of housing 56, four partitions 63 having a trapezoidal transverse section are provided in a protruding condition at 90° intervals.

Rotation member 53 includes; an annular base 77, and four vanes 78a, 78b, 78c, and 78d provided on the outer peripheral surface of base 77 at 90° intervals, and is fixed to a front end of inlet camshaft 115.

First to fourth vanes 78a to 78d are arranged within respective spaces between the partitions 63, to separate the spaces into front and back in the rotation direction, and form advance-angle-side-hydraulic chambers 82 and retarded-angle-side-hydraulic chambers 83.

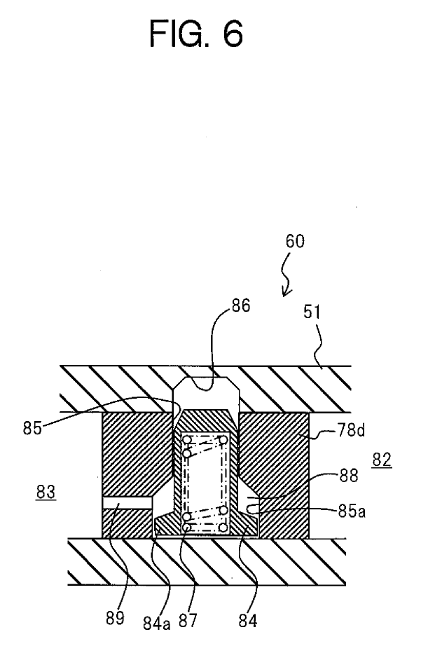

Locking mechanism 60 is a mechanism for locking the rotation phase to a target for the engine starting, and as illustrated in FIG. 6, locks rotation member 53 at a relative angular position corresponding to the target, by inserting a lock pin 84 into an engaging hole 86.

At the time of engine 101 starting and in a state where the oil pressure of advance-angle-side-hydraulic chamber 82 and retarded-angle-side-hydraulic chamber 83 drops and a discharge rate of an oil pump 97 described later is low, when a cam reaction force generated by cranking of engine 101 acts on inlet camshaft 115, the rotation phase fluctuates greatly, thus deteriorating the starting performance of engine 101.

Therefore, the rotation phase of inlet camshaft 115 is mechanically locked by locking mechanism 60 so that the rotation phase of inlet camshaft 115 is maintained constant at the time of engine 101 starting.

Locking mechanism 60 will be explained later in detail.

Hydraulic circuit 54 includes two types of oil pressure passages, namely; a first oil pressure passage 91 that controls supply and discharge of hydraulic fluid with respect to advance-angle-side-hydraulic chamber 82, and a second oil pressure passage 92 that controls supply and discharge of hydraulic fluid with respect to retarded-angle-side-hydraulic chamber 83.

A supply passage 93 or a drain passage 94 is connected to both oil pressure passages 91 and 92 via an electromagnetic switching valve 95.

In supply passage 93, an engine-driven oil pump 97 that forcefully feeds hydraulic fluid in an oil pan 96 is provided, while a downstream end of drain passage 94 is communicated with oil pan 96.

First oil pressure passage 91 is connected to four branching paths 91d that are formed substantially radially in base 77 of rotation member 53 and communicated with respective advance-angle-side-hydraulic chambers 82, and second oil pressure passage 92 is connected to four oil galleries 92d that open to respective retarded-angle-side-hydraulic chambers 83.

A spool valve in electromagnetic switching valve 95 relatively controls switching between respective oil pressure passages 91 and 92 and supply passage 93 and drain passage 94.

Engine control apparatus 201 controls power distribution to an electromagnetic actuator 99 that drives electromagnetic switching valve 95, based on a duty control signal superimposed with a dither signal, to thereby switch between; a state in which supply and discharge of the hydraulic fluid with respect to advance-angle-side-hydraulic chamber 82 and retarded-angle-side-hydraulic chamber 83 are both stopped, a state in which the hydraulic fluid is supplied to advance-angle-side-hydraulic chamber 82 and the hydraulic fluid is discharged from the retarded-angle-side-hydraulic chamber 83, and a state in which the hydraulic fluid is discharged from advance-angle-side-hydraulic chamber 82 and the hydraulic fluid is supplied to retarded-angle-side-hydraulic chamber 83.

Here, in the state in which the hydraulic fluid is supplied to advance-angle-side-hydraulic chamber 82 and the hydraulic fluid is discharged from retarded-angle-side-hydraulic chamber 83, rotation member 53 rotates toward an advance angle side. As a result, an opening period of inlet valve 105 relatively changes toward the advance angle side with respect to a piston position.

Moreover, in the state in which the hydraulic fluid is discharged from advance-angle-side-hydraulic chamber 82 and the hydraulic fluid is supplied to retarded-angle-side-hydraulic chamber 83, rotation member 53 rotates toward a retard angle side. As a result, the opening period of inlet valve 105 relatively changes toward the retard angle side with respect to the piston position.

Furthermore, in the state in which supply and discharge of the hydraulic fluid with respect to advance-angle-side-hydraulic chamber 82 and retarded-angle-side-hydraulic chamber 83 are both stopped, the rotation phase at that time is maintained.

In this manner, variable valve timing mechanism 114 is a mechanism that, as indicated by arrow 302 in FIG. 5, changes the central phase SP of the valve working angle of inlet valve 105 without changing the valve working angle OA and the maximum valve lift VL of inlet valve 105. Variable valve timing mechanism 114 can change the central phase of the valve working angle of inlet valve 105 to an arbitrary position between the most retard angle position and the most advance angle position by changing a duty ratio of the control signal.

Engine control apparatus 201 detects the rotation phase of inlet camshaft 115 based on the detection signals of crank angle sensor 203 and cam angle sensor 204, and feed-back controls the duty ratio of electromagnetic actuator 99 so that the actual rotation phase approaches the target in accordance with an engine operation condition such as the engine load or the engine rotation speed.

Here, locking mechanism 60 in variable valve timing mechanism 114 is explained in detail with reference to FIG. 6.

Locking mechanism 60 includes; a slide hole 85 formed along the axial direction of inlet camshaft 115 to the vane 78d, a lock pin 84 slidably provided in slide hole 85, a latch hole 86 formed in an inner end face of cam sprocket 51, and a coil spring 87 that biases lock pin 84 toward latch hole 86 (cam sprocket 51).

When the relative angle of vane 78d with respect to cam sprocket 51 is at an angular position corresponding to the target for the engine starting, an inside of slide hole 85 and latch hole 86 are formed so as to be continuously lined up on the same axis. The target for the engine starting is the most retard angle position or a position deviated from the most retard angle position toward the advance angle side.

Lock pin 84 is biased toward latch hole 86 side by the spring force of coil spring 87 fitted in a state with an elastic force being applied toward an outer end, and when the inside of slide hole 85 and latch hole 86 are lined up on the same axis which is the target for the engine starting, lock pin 84 is inserted into latch hole 86 by the spring force of coil spring 87.

An engaging surface on the retard angle side and/or an engaging surface on the advance angle side of latch hole 86 can be formed stepwise or in an inclined surface in which a side into which lock pin 84 is inserted becomes wide, and when the actual rotation phase returns to near the target for the engine starting, return to the target for the engine starting can be enhanced by being guided by the inclined surface or the stepwise engaging surface.

In particular, in a case where the lock position is set at a position deviated from the most retard angle position toward the advance angle side, the end face of lock pin 84 bumps against the inclined surface of latch hole 86 due to the spring force of coil spring 87 when engine 101 stops at the most retard angle position, to thereby generate a force for relatively rotating rotation member 53 toward the advance angle side, and the rotation member 53 can be finally stopped and locked at the position deviated from the most retard angle position toward the advance angle side.

At a rear end of slide hole 85, an enlarged diameter part 85a is formed, and on an outer end of lock pin 84, a flange 84a is formed. Flange 84a is inserted into and fitted to enlarged diameter part 85a to thereby form a toroidal pressure chamber 88 surrounded by an inner peripheral wall of slide hole 85, lock pin 84, and an outer peripheral wall. Pressure chamber 88 is communicated with retard hydraulic chamber 83 via a connection passage 89.

Here, when the hydraulic fluid is supplied to retard hydraulic chamber 83 to increase the oil pressure in retard hydraulic chamber 83, and the oil pressure of pressure chamber 88 overcomes the spring force of coil spring 87, a force is applied in a direction of pulling out lock pin 84 from latch hole 86 against the spring force of coil spring 87, and lock pin 84 is pulled out from latch hole 86 and becomes a lock release state.

Moreover, also in the case where, in order to change the rotation phase toward the advance angle side, the hydraulic fluid is discharged from retard hydraulic chamber 83, the vane rotates so as to narrow retard hydraulic chamber 83 and drain of the hydraulic fluid via drain passage 94 is limited, and thus, the oil pressure in retard hydraulic chamber 83 as well as the pressure of pressure chamber 88 is maintained at a pressure that overcomes the spring force of coil spring 87, to thereby maintain the lock release state.

Accordingly, for example, when the hydraulic fluid is supplied to retard hydraulic chamber 83 in the lock state, the lock release state results, and if the target for startup is the most retard angle position, the position is held, or when the target for the engine starting is on the advance angle side rather than the most retard angle position, the position can be changed toward the retard angle side.

Moreover, also in the case where the position is changed toward the advance angle side, because as mentioned above, the pressure of pressure chamber 88 is maintained at the pressure that overcomes the spring force of coil spring 87, the rotation phase can be changed toward the advance angle side up to a target phase in accordance with the operation condition, without locking by locking mechanism 60.

Furthermore, in a stopping process of engine 101, the discharge rate of oil pump 97 decreases to thereby decrease the pressure of retard hydraulic chamber 83, and according to this, when the pressure of hydraulic chamber 88 of locking mechanism 60 drops and cannot resist the spring force of coil spring 87, lock pin 84 is biased in a direction to protrude from slide hole 85 due to the spring force of coil spring 87.

Accordingly, in the stopping process of engine 101, when the inside of slide hole 85 and latch hole 86 are lined up on the same axis, lock pin 84 biased toward latch hole 86 due to the spring force of coil spring 87, is inserted into latch hole 86 to give the lock state.

In order to reliably lock the rotation phase in the stopping process of engine 101, the rotation phase can be controlled to a position advanced more than the target for the engine starting and then electromagnetic switching valve 95 can be controlled so as to gradually change the rotation phase in the retard angle direction.

In the lock state due to locking mechanism 60, because rotation member 53 is fixed with respect to cam sprocket 51, an assembly angle between inlet camshaft 115 and cam sprocket 51 is fixed, and valve timing of inlet valve 105 is mechanically fixed.

Accordingly, at the time of engine 101 starting, even if the oil pressure drops in oil pressure chambers 82 and 83, if the rotation phase is mechanically locked by locking mechanism 60, inlet valve 105 is stably opened at the valve timing most suitable for the engine starting, and high starting performance can be maintained.

On the other hand, in a state in which the rotation phase is not locked at the target for the engine starting by locking mechanism 60, the rotation phase fluctuates at the time of the engine starting. When fuel injection is started in this state, the air-fuel ratio fluctuates greatly, the exhaust properties deteriorate, and combustion stability decreases, so that starting performance of engine 101 deteriorates.

However in the case where the rotation phase is stopped at a position advanced more than the target for the engine starting due to engine stall or the like, inlet valve 105 is opened with cranking, so that the cam reaction force acts to relatively rotate inlet camshaft 115 in the retard angle direction to approach the target for the engine starting, and locking mechanism 60 locks the rotation phase at a point in time when the rotation phase reaches the target for the engine starting.

Accordingly, in the case where the rotation phase is stopped at a position advanced more than the target for the engine starting, if supply of fuel to engine 101 is made to standby from start of cranking until the rotation phase returns to the target for the engine starting, deterioration of the exhaust properties or a decrease of the combustion stability can be suppressed, even if fuel injection is started thereafter.

However, because the rotation fluctuation of engine 101 is large during cranking, and the actual rotation phase may not be detected accurately, fuel injection may be started before the rotation phase returns to the target for the engine starting, or the engine starting time may become long because fuel injection is not started although the rotation phase returns to the target for the engine starting.

Here as described above, there is a state in which locking by locking mechanism 60 is not performed because the reaction force due to opening of inlet valve 105 at the time of cranking acts in a direction of retarding the rotation phase, and in the case where cranking is started from a state with the rotation phase being stopped to the advance angle side from the target for the engine starting, the rotation phase gradually changes in the retard angle direction every time the reaction force for opening inlet valve 105 is generated, and the rotation phase returns to the target for the engine starting to give the lock state.

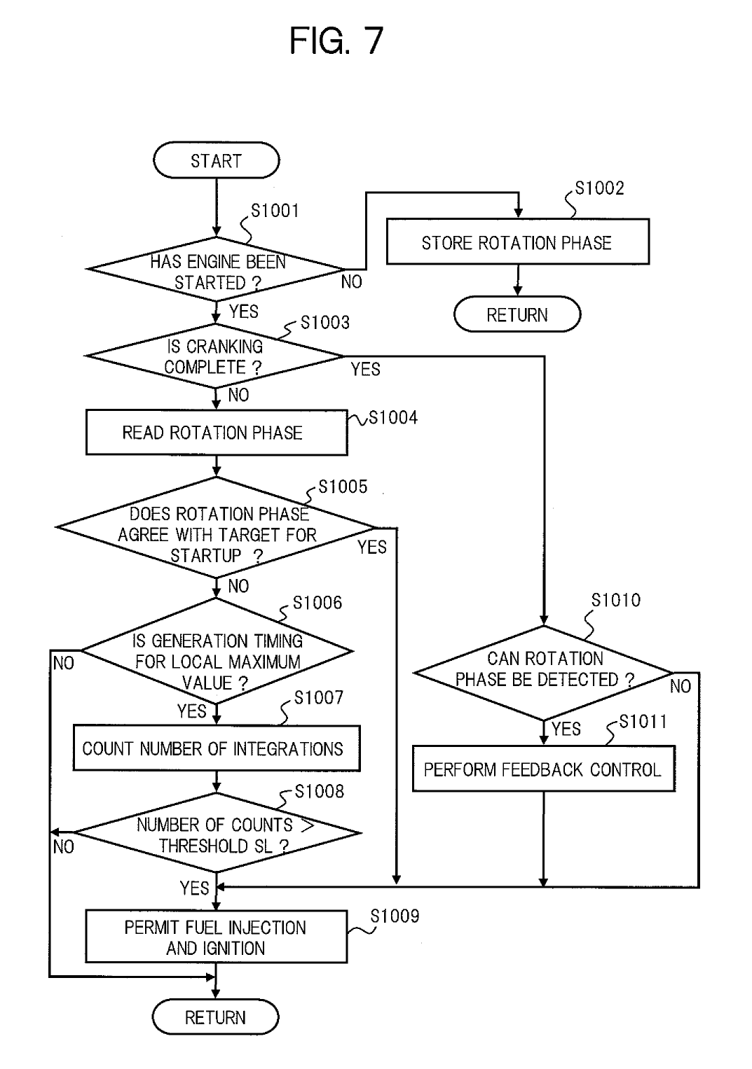

Therefore in the embodiment, it is estimated that the rotation phase has returned to the target for the engine starting to start fuel injection, as illustrated in the flowchart in FIG. 7.

The routine illustrated in the flowchart in FIG. 7 is executed interruptingly at regular intervals. At first, in step S1001, a starting condition of engine 101 is determined from a signal from ignition switch 205 or the engine rotation speed.

Then, when the situation is not at the time of engine starting 101 but after engine 101 starting, control proceeds to step S1002, and the latest value of the rotation phase detected based on the signals of crank angle sensor 203 and cam angle sensor 204 is stored.

Accordingly, at the time of engine 101 operating, the current rotation phases are sequentially stored, and a storing process is repeated until immediately before stopping the engine, so that finally, the rotation phase at the time of stopping engine 101 is stored.

On the other hand, when engine 101 starting is determined in step S1001, control proceeds to step S1003 to determine whether or not cranking is being performed.

When in a cranking state in which engine 101 is rotated by a starter motor, control proceeds to step S1004, and a stored value of the rotation phase, that is, the rotation phase at the time of stopping engine 101 is read.

Then, in the next step S1005, it is determined whether or not the rotation phase read in step 81004 agrees with the target for the engine starting.

In the case where engine 101 is started up in a state in which locking mechanism 60 locks the rotation phase at the time of stopping the engine, and the rotation phase agrees with the target for the engine starting, the valve timing of inlet valve 105 is mechanically held in a suitable state for the engine starting, so that control proceeds to step S1009, and fuel injection and ignition is permitted.

Accordingly, when the rotation phase returns to the target for the engine starting and is locked at the time of stopping engine 101, fuel injection and ignition are immediately permitted at the time of restarting the engine, and fuel injection is started if the condition for starting fuel injection, such as determination of the cylinder which injects fuel, is satisfied. Because engine 101 can be started up in short time, and the rotation phase is mechanically locked at the target for the engine starting, deterioration of the exhaust properties at the time of engine starting can be avoided.

On the other hand, in step S1005, when the rotation phase at the time of stopping the engine does not agree with the target for the engine starting, and the engine is started up in a state with the rotation phase being advanced more than the target for the engine starting, control proceeds to step S1006.

In step S1006, it is determined whether or not it is timing for when a reaction force for opening of inlet valve 105 takes a local maximum value.

As the determination of generation timing of the local maximum value, a predetermined crank angle position after an intake top dead center of each cylinder can be predetermined as the timing when the reaction force takes the local maximum value.

Specifically, for example, the generation timing of the local maximum value can be set to crank angle ATDC=90 degrees, which is close to the timing when the valve lift of inlet valve 105 becomes a maximum.

In other word, in the determination of the generation timing of the local maximum value of the cam reaction force, execution of the opening operation of inlet valve 105 in the respective cylinders is determined.

Accordingly, for example, in a four-cylinder engine in which a stroke phase difference between the cylinders is a crank angle=180 degrees, because inlet valve 105 is opened for each crank angle of 180 degrees, the generation timing of the local maximum value can be determined for each crank angle of 180 degrees or a crank angle of an integral multiple of the crank angle of 180 degrees.

The determination of the generation timing of the local maximum value can be performed based on the signal of crank angle sensor 203, and can also be determined based on the signal of cam angle sensor 204.

Then, in the case where it is not the generation timing of the local maximum value, the routine is finished as is.

On the other hand, when it is determined that it is the generation timing of the local maximum value, control proceeds to step S1007, and the value of a counter PEAKCONT for counting the number of integrations of the generation timing of the local maximum value is increased by a predetermined number of steps.

The value of the counter PEAKCONT indicates the number of integrations of opening operations of inlet valve 105 from engine 101 starting.

In step S1008, it is determined whether or not the value of the counter PEAKCONT exceeds a threshold SL to thereby determine whether or not the rotation phase of inlet camshaft 115 has changed to the target for the engine starting.

That is, the cam reaction force acts on inlet camshaft 115 and the rotation phase of inlet camshaft 115 is changed in the retard angle direction due to opening of inlet valve 105 accompanying cranking, and the number of generations of the local maximum value, that is, the number of integrations of opening operations of inlet valve 105 is proportional to an angle change quantity of the rotation phase of inlet camshaft 115 in the retard angle direction.

Accordingly, whether or not the rotation phase has changed in the retard angle direction up to the target for the engine starting can be determined from the value of the counter PEAKCONT.

Here the number of generations of the local maximum value required until reaching the target for the engine starting increases as the angle difference between the rotation phase at the time of stopping the engine and the target for the engine starting becomes large. Therefore, in engine control apparatus 201, the threshold SL is changed to a larger value, as the angle difference between the rotation phase at the time of stopping the engine and the target for the engine starting becomes large, that is, as the rotation phase at the time of stopping the engine is advanced.

In other words, a value obtained by dividing the angle difference between the rotation phase at the time of stopping the engine and the target for the engine starting, by the angle change quantity of the rotation phase in the retard angle direction generated per one opening of inlet valve 105 is set as the threshold, thereby enabling to estimate that the rotation phase of inlet camshaft 115 has changed up to the target for the engine starting, when the value of the counter PEAKCONT exceeds the threshold SL.

Moreover, the angle change quantity of the rotation phase in the retard angle direction generated per one opening of inlet valve 105 changes according to the intensity of the cam reaction force, and the intensity of the cam reaction force increases as the valve working angle and the maximum valve lift become large.

Therefore, the threshold SL is corrected to be smaller as the valve working angle and the maximum valve lift, which are variable due to variable valve lift mechanism 113, become larger.

That is, when the valve working angle and the maximum valve lift are large, the cam reaction force increases, and the angle at which the rotation phase is displaced to the retard angle side by opening inlet valve 105 once becomes large.

Therefore, the rotation phase can return to the target for the engine starting with less number of integrations, and hence, the threshold SL is corrected to be smaller as the valve working angle and the maximum valve lift become larger.

Moreover, when the temperature of the hydraulic fluid of variable valve timing mechanism 114 is low, the friction increases, and the angle at which the rotation phase is displaced in the retard angle direction by opening the inlet valve 105 once becomes small. Therefore, the threshold SL is corrected to be larger as the temperature of variable valve timing mechanism 114 becomes lower.

The temperature of the hydraulic fluid of variable valve timing mechanism 114 can be estimated from the temperature of the cooling water or lubricant of engine 101. Moreover, a temperature sensor that detects the temperature of the hydraulic fluid of variable valve timing mechanism 114 may be provided.

Furthermore, instead of correcting the threshold SL, the value of the counter PEAKCONT or a stepsize for increasing the counter PEAKCONT for each generation of the local maximum value to be compared with the threshold SL can be corrected according to the angle difference between; the rotation phase at the time of stopping the engine and the target for the engine starting, the valve working angle and the maximum valve lift that are variable due to variable valve lift mechanism 113, or the temperature of the hydraulic fluid of variable valve timing mechanism 114.

Specifically, the value of the counter PEAKCONT or the stepsize are corrected to be smaller as the angle difference between the rotation phase at the time of stopping the engine and the target for the engine starting become larger.

Furthermore, the value of the counter PEAKCONT or the stepsize are corrected to be larger as the valve working angle and the maximum valve lift become larger.

Moreover, the value of the counter PEAKCONT or the stepsize are corrected to be smaller as the temperature of the hydraulic fluid of variable valve timing mechanism 114 becomes lower.

In step S1008, in the case where it is determined that the value of the counter PEAKCONT does not exceed the threshold SL, it is estimated that an actual rotation phase is advanced more than the target for the engine starting to be locked by locking mechanism 60, and the routine is terminated as is, to thereby restrict fuel injection and ignition until it is determined that the value of the counter PEAKCONT exceeds the threshold SL.

In a state in which the rotation phase is not locked by locking mechanism 60, the actual rotation phase fluctuates greatly and the valve timing of inlet valve 105 fluctuates greatly at the time of engine 101 starting. If fuel injection is performed in this state, the air-fuel ratio fluctuates greatly and the exhaust properties are deteriorated. Therefore, fuel injection is restricted until the rotation phase is locked at the target for the engine starting by locking mechanism 60.

On the other hand, in step S1008, in the case where it is determined that the value of the counter PEAKCONT exceeds the threshold SL, it is estimated that the actual rotation phase has been retarded until the target for the engine starting to be locked by locking mechanism 60, and is locked by locking mechanism 60, and control proceeds to step S1009 to permit fuel injection and ignition.

During cranking, because the pressure in oil pressure chambers 82 and 83 is low and lock pin 84 is biased toward cam sprocket 51 by the spring force of coil spring 87, the rotation phase advanced more than the target for the engine starting in the engine stopping state is retarded every time inlet valve 105 is opened by the action of the cam reaction force, and is retarded up to a state in which the inside of slide hole 85 and latch hole 86 are lined up on the same axis. At this point in time, lock pin 84 is inserted into latch hole 86 and becomes in the lock state in which retard change and advance change are blocked.

Then, when the rotation phase has reached the target for the engine starting and locking mechanism 60 has locked the rotation phase, the rotation phase is maintained constant even if the pressure in oil pressure chambers 82 and 83 drops, and the air-fuel ratio does not fluctuate greatly even when fuel injection is started.

Therefore, fuel injection and ignition are permitted.

Here, the determination of the generation timing of the local maximum value of the cam reaction force determines the integrated number of rotations of engine 101. Therefore, even in a state in which rotation fluctuation is great such as during cranking, reliable determination is possible.

On the other hand, when a phase difference between the detection signal of crank angle sensor 203 and the detection signal of cam angle sensor 204 is measured to detect the actual rotation phase, a detection error becomes large in a state with the rotation fluctuation being large, such as during cranking.

Accordingly, if it is estimated whether or not the actual rotation phase has reached the target for the engine starting based on whether or not the value of the counter PEAKCONT exceeds the threshold SL, to determine to permit or restrict fuel injection and ignition, deterioration of the exhaust properties at the time of the engine starting can be avoided by starting fuel injection and ignition before the rotation phase reaches the target for the engine starting, and the situation where the time of the engine starting becomes long because fuel injection and ignition are not started although the rotation phase has reached the target for the engine starting, can be suppressed.

When completion of cranking is determined in step S1003, control proceeds to step S1010, and it is determined whether or not the rotation phase can be detected based on the detection signals of crank angle sensor 203 and cam angle sensor 204.

Specifically, when fluctuation per unit time of rotation speed NE of engine 101 decreases down to a predetermined value or less, and the engine rotation is stabilized, it is determined that the rotation phase can be detected based on the detection signals of crank angle sensor 203 and cam angle sensor 204.

That is to say, the predetermined value for determining rotation fluctuation is set so that it can be determined whether or not detection accuracy of the rotation phase can be ensured based on the detection signals of crank angle sensor 203 and cam angle sensor 204. If the fluctuation per unit time of the rotation speed NE of engine 101 is equal to or less than the predetermined value, it is determined that the rotation phase can be detected with sufficient accuracy based on the detection signals of crank angle sensor 203 and cam angle sensor 204.

When the engine rotation is not yet stabilized immediately after completion of cranking, it is determined that the rotation phase may not be detected, and control proceeds to step S1009, bypassing the next step S1011, to thereby perform fuel injection and ignition, with the rotation phase at the target for the engine starting being maintained by locking mechanism 60.

On the other hand, in step S1010, when determined that the engine rotation is stabilized and the rotation phase can be detected with sufficient accuracy based on the detection signals of crank angle sensor 203 and cam angle sensor 204, control proceeds to step S1011, and the actual rotation phase is detected based on the detection signals of crank angle sensor 203 and cam angle sensor 204, and the manipulated variable of variable valve timing mechanism 114 is feedback controlled so that the actual rotation phase approaches a target phase.

Here, when the oil pressure is controlled so as to change the actual rotation phase from the target for the engine starting, locking by locking mechanism 60 is released to give a state where the rotation phase can be changed.

In the embodiment, the construction is such that lock pin 84 of locking mechanism 60 moves in the axial direction of inlet camshaft 115, however, for example, a locking mechanism that can switch the lock state and the lock release state by moving lock pin 84 in the radial direction of inlet camshaft 115 may be used.

Moreover, lock pin 84 can be pulled out from latch hole 86 not by the oil pressure but by an electromagnetic solenoid.

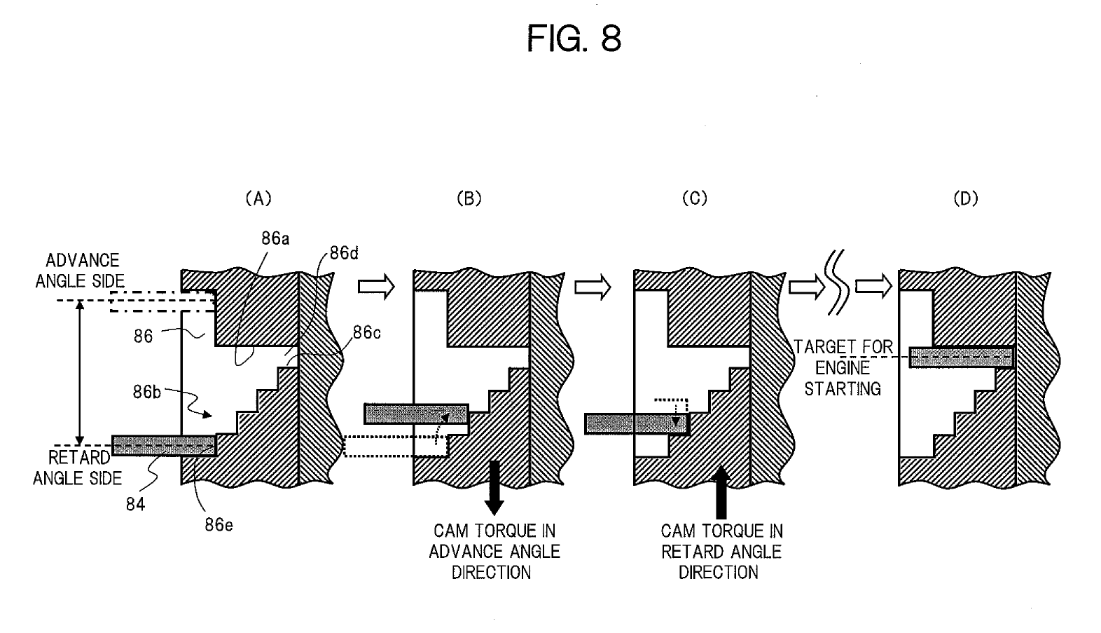

Furthermore, latch hole 86 can be formed in step-wise as illustrated in FIG. 8.

That is, an engagement face 86a on the advance angle side in a vane circumferential direction of latch hole 86 is formed in a downward slope, while an engagement part 86b on the retard angle side facing the engagement face 86a on the advance angle side in a circumferential direction is formed in multiple step-wise.

Here, in engagement part 86b on the retard angle side, a rising height of respective steps from the highest retard angle side to the lowest advance angle side is set uniformly, and a position where lock pin 84 is inserted into a concave portion 86d placed between a rising face 86c from the lowest position and engagement face 86a on the advance angle side is set to the rotation phase of the target for the engine starting.

The end of lock pin 84 is pressed against the highest step face 86e of engagement part 86b on the most retard angle position due to the biasing force of coil spring 87.

Accordingly, at the time of stopping engine 101, when the rotation phase is stopped on the retard angle side more than the target for the engine starting, for example, at the most retard angle position, then as illustrated in FIG. 8A, the end of lock pin 84 is pressed against the highest step face 86e of engagement part 86b on the retard angle side.

When cranking is performed from such a state with restart of the engine, the cam reaction force acting on the retard angle side and the cam reaction force acting on the advance angle side are generated as inlet valve 105 is opened. However, when the cam reaction force acts on the retard angle side, a side face of lock pin 84 is pressed against rising face 86c of engagement part 86b on the retard angle side to thereby restrict displacement of lock pin 84 in the retard angle direction.

However, when the cam reaction force acts on the advance angle side, relative movement of lock pin 84 toward the advance angle side is permitted.

Therefore, as illustrated in FIG. 8B, when lock pin 84 relatively moves toward the advance angle side, and the end thereof comes off from the highest step face 86e so as to face a lower step face 86e, lock pin 84 is pushed out by the biasing force of spring 87, and as illustrated in FIG. 8C, the side face of lock pin 84 engages with rising face 86c lower by one step.

That is to say, even if a torque for changing the rotation phase toward the retard angle side is generated more strongly than a torque for changing the rotation angle toward the advance angle side, a retard angle change of the actual rotation phase is restricted with respect to the torque for changing the rotation phase toward the retard angle side, by engaging the side face of lock pin 84 with rising face 86c of engagement part 86b on the retard angle side, and the actual rotation phase is changed toward the advance angle side by the torque acting on the advance angle side.

Accordingly, the rotation phase gradually changes toward the advance angle side every time inlet valve 105 is opened, and finally, as illustrated in FIG. 8D, lock pin 84 is inserted into concave portion 86d. In the state with lock pin 84 being inserted into concave portion 86d, displacement of lock pin 84 in the advance angle direction and the retard angle direction is restricted, so that the state in which lock pin 84 is inserted into concave portion 86d is maintained and the target for the engine starting is maintained, even if either the cam reaction force acting in the retard angle direction or the cam reaction force acting in the advance angle direction is generated.

That is to say, if the engaging hole 86 is one with a shape as illustrated in FIG. 8, then in both the case where the rotation phase is stopped at a position advanced more than the target for the engine starting, and the case where the rotation phase is stopped at a position more retarded than the target for the engine starting, the rotation phase gradually approaches the target for the engine starting every time inlet valve 105 is opened since the engine starting.

Accordingly, if it is discriminated whether or not a stopped position of the rotation phase is at a position advanced or a position retarded from the target for the engine starting, and the threshold SL of the number of generations of the local maximum value of the cam reaction force is set according to the discrimination, it can be accurately determined that the actual rotation phase reaches the target for the engine starting, even when the rotation phase is stopped at the position retarded more than the target for startup.

The entire contents of Japanese Patent Application No. 2009-068845, filed Mar. 19, 2009 are incorporated herein by reference.

While only selected embodiments have been chosen to illustrate the present invention, it will be apparent to those skilled in the art from this disclosure that various changes and modifications can be made herein without departing from the scope of the invention as defined in the appended claims.

Furthermore, the foregoing descriptions of the embodiments according to the present invention are provided for illustration only, and not for the purpose of limiting the invention as defined by the appended claims and their equivalents.

I (we) claim:

1. A apparatus for controlling an engine including a variable valve timing mechanism that changes a rotation phase of a camshaft with respect to a crankshaft and has a locking mechanism for locking the rotation phase of the camshaft to a target for the engine starting, the control apparatus of the engine comprising:
an integration unit that integrates valve opening frequencies of an engine valve to be driven by the camshaft;
a determination unit that determines whether or not the variable valve timing mechanism is locked to the target at the time of the engine starting; and
a restriction unit that restricts supply of fuel to the engine from the commencement of the engine starting until an integrated value of the valve opening frequencies reaches a threshold, in a case where the variable valve timing mechanism is not locked to the target.

2. A apparatus for controlling an engine according to claim 1, wherein the restriction unit includes:
a first setting unit that variably sets the threshold according to a difference between the target and the rotation phase at the time of stopping the engine.

3. A apparatus for controlling an engine according to claim 1, wherein the restriction unit includes:
a first correction unit that corrects the integrated value to be compared with the threshold, according to a difference between the target and the rotation phase at the time of stopping the engine.

4. A apparatus for controlling an engine according to claim 1, wherein the engine comprises:
a variable valve lift mechanism that makes a valve working angle of the engine valve variable, together with the variable valve timing mechanism, and
the restriction unit includes:
a second setting unit that variably sets the threshold according to the valve working angle, which is made variable by the variable valve lift mechanism.

5. A apparatus for controlling an engine according to claim 1, wherein the engine comprises:
a variable valve lift mechanism that makes a valve working angle of the engine valve variable, together with the variable valve timing mechanism, and
the restriction unit includes:
a second correction unit that corrects the integrated value to be compared with the threshold, according to the valve working angle which is made variable by the variable valve lift mechanism.

6. A apparatus for controlling an engine according to claim 1, wherein the restriction unit includes:
a detection unit that detects temperature of the variable valve timing mechanism; and
a third setting unit that variably sets the threshold according to the temperature of the variable valve timing mechanism.

7. A control apparatus for controlling an engine according to claim 1, wherein the restriction unit includes:
a temperature detection unit that detects temperature of the variable valve timing mechanism; and
a third correction unit that corrects the integrated value to be compared with the threshold, according to the temperature of the variable valve timing mechanism.

8. A apparatus for controlling an engine according to claim 1, wherein
in a case where the rotation phase of the camshaft is advanced more than the target, the restriction unit restricts supply of fuel to the engine from the commencement of the engine starting until the integrated value of the valve opening frequencies reaches the threshold.

9. A apparatus for controlling an engine according to claim 1, wherein the determination unit includes:
a phase detection unit that detects the rotation phase;
a storage unit that updates and stores the rotation phase detected by the phase detection unit; and
a read unit that reads the rotation phase stored in the storage unit at the time of the engine starting.

10. A apparatus for controlling an engine according to claim 1, wherein
the integration unit increases the integrated value of the valve opening frequencies of the engine valve for each crank angle at which valve lift of the engine valve becomes a maximum.

11. A apparatus for controlling an engine according to claim 1, wherein
the integration unit increases the integrated value of the valve opening frequencies of the engine valve for every timing when a reaction force with respect to opening of the engine valve takes a local maximum value.

12. A apparatus for controlling an engine including a variable valve timing mechanism that changes a rotation phase of a camshaft with respect to a crankshaft and has a locking mechanism for locking the rotation phase of the camshaft to a target for the engine starting, the control apparatus of the engine comprising:
an integration means that integrates valve opening frequencies of an engine valve to be driven by the camshaft;
a determination means that determines whether or not the variable valve timing mechanism is locked to the target at the time of the engine starting; and
a restriction means that restricts supply of fuel to the engine from the commencement of the engine starting until an integrated value of the valve opening frequencies reaches a threshold, when the variable valve timing mechanism is not locked to the target.

13. A method of controlling an engine including a variable valve timing mechanism that changes a rotation phase of a camshaft with respect to a crankshaft and has a locking mechanism for locking the rotation phase of the camshaft to a target for the engine starting, comprising steps of:
determining whether or not the variable valve timing mechanism is locked to the target at the commencement of the engine starting;
integrating valve opening frequencies of an engine valve to be driven by the camshaft in a case where the variable valve timing mechanism is not locked to the target; and
restricting supply of fuel to the engine until an integrated value of the valve opening frequencies reaches a threshold.

14. A method of controlling an engine according to claim 13, further including a step of:
variably setting the threshold according to a difference between the target and the rotation phase at the time of stopping the engine.

15. A method of controlling an engine according to claim 13, further including a step of:
correcting the integrated value to be compared with the threshold, according to a difference between the target and the rotation phase at the time of stopping the engine.

16. A method of controlling an engine according to claim 13, wherein the engine comprises a variable valve lift mechanism that makes a valve working angle of the engine valve variable, together with the variable valve timing mechanism, and the control method further includes a step of:
setting the threshold variable according to the valve working angle which is made variable by the variable valve lift mechanism.

17. A method of controlling an engine according to claim 13, wherein the engine comprises a variable valve lift mechanism that makes a valve working angle of the engine valve variable, together with the variable valve timing mechanism, and the control method further includes a step of:
correcting the integrated value to be compared with the threshold, according to the valve working angle which is made variable by the variable valve lift mechanism.

18. A method of controlling an engine according to claim 13, further including steps of:
detecting temperature of the variable valve timing mechanism; and
variably setting the threshold according to the temperature of the variable valve timing mechanism.

19. A method of controlling an engine according to claim 13, further including steps of:
detecting temperature of the variable valve timing mechanism; and
correcting the integrated value to be compared with the threshold, according to the temperature of the variable valve timing mechanism.

20. A method of controlling an engine according to claim 13, wherein
the step of determining whether or not the variable valve timing mechanism is locked to the target determines whether or not the rotation phase is advanced more than the target, and
the step of restricting fuel supply restricts supply of fuel to the engine until the integrated value of the valve opening frequencies reaches the threshold, in a case where the rotation phase is advanced more than the target.
